(19) United States
(12) Patent Application Publication
(10) Pub. No.: US 2018/0342015 A1
(43) Pub. Date: Nov. 29, 2018

(54) AN ELECTRONIC SECURITY SYSTEM AND METHOD FOR INVESTMENT TRANSACTION

(71) Applicant: CASHWERKZ PTY LTD, Sydney, NSW (AU)

(72) Inventors: Mark Austin, Chatswood (AU); Gregory Martin Bartlett, Northbridge (AU)

(73) Assignee: CASHWERKZ PTY LTD, Sydney, NSW (AU)

(21) Appl. No.: 15/779,085

(22) PCT Filed: Nov. 11, 2016
(86) PCT No.: PCT/AU2016/051136

§ 371 Date: May 25, 2018

(30) Foreign Application Priority Data
Nov. 26, 2015 (AU) 2015904889

(51) Int. Cl. G06Q 40/06; G06Q 40/02; G06F 21/62; G06Q 20/40; G06Q 20/38

(52) U.S. Cl. CPC G06Q 40/06; G06Q 40/02; G06Q 20/3821; G06Q 20/405; G06Q 20/4014; G06F 21/6245

(57) ABSTRACT

The present invention provides an electronic security method for investment transaction comprising the step of: receiving personal information data of a customer from a client system; receiving one or more document files containing information of the customer from the client system, wherein the one or more document files comprise one or more images, identification documents, and bank statements; connecting to a secured database to verify the information of the personal information data; providing one or more financial products for the customer to select for investment; receiving an investment order for one or more financial products; preparing and forwarding an investment order ticket to a financial institution; and forwarding a settlement command to a settlement facility.

### TECHNICAL FIELD

The present invention relates to an electronic security system and method for investment transaction. More particularly, there is provided a computerized system for managing personal portfolio such as fixed income security.

### BACKGROUND

It is critical for financial institutions, professionals working within the financial sector, and bullion sectors as well as other regulated entities to know their customers very well.

Under Anti-money-laundering and Counter-Terrorism (AML-CT) legislation, Know Your Customers (KYC) policy refers to documentation which sets out a business approach to ensuring that it can effectively identify, verify and monitor its customers and the financial transactions in which they engage, relative to the risks of money laundering and terrorism financing. Note that Financial Service legislation also uses the term KYC, but this is not to be confused with KYC in AML/CTF. KYC in Financial Services legislation relates to the understanding of a client's financial position, not their risk of practicing ML/TF.

All financial institutions are now required to comply with the new customer identification and due diligence laws for opening up an account for their customers. Not only do the financial institutions need to know their customer as a person, and their business, they also need to understand what sort of business the customers are doing, and why they're doing it.

The new customer identification and due diligence laws are designed to comply with international obligations under the Financial Action Task Force (FATF) on money laundering. It is on-going customer due diligence (OCDD).

There are serious consequences for getting this wrong: potentially unlimited fines for a corporation, and criminal penalties for company officials. Merely collecting customer information is not enough for an effective KYC policy. Reliable and independent documentation should be used to support and confirm the identification details that a customer provides. For example, citing an original primary photographic identification document such as a passport or drivers licence.

Previous each financial institution has to carry out their own process to satisfy the requirement of KYC for opening up a new account. It is becoming very time consuming and tedious for a customer to move investment from one bank to another because each time the new financial institution has to request a large amount of documents to verify a person.

It is also difficult to compare different investment products from one financial institution to another. Each may be different in objective, starting requirements, maturity time, and risk rating . . . etc. It is difficult to collect the investment products information from different financial organizations and compare them in light of the particular situation of the client.

U.S. Pat. No. 7,917,433 discloses an automated method or computer program product that is provided for processing a large deposit that exceeds an established deposit insurance limit so that the large deposit is fully insured. The large deposit is received from a depositor by first one of a plurality of unaffiliated banks. A processor receives an order placed by the first unaffiliated bank to process the large deposit. The first unaffiliated bank offers a first set of deposit terms to a first depositor. The processor assigns a portion of the large deposit not exceeding the established deposit insurance limit to a second one of the plurality of unaffiliated banks. The second unaffiliated bank offers a second set of deposit terms to a second depositor. The processor calculates the amount of a present value payment to be transferred between the first unaffiliated bank and the second unaffiliated bank to compensate for differences between the first and second sets of deposit terms.

Another prior art document US Patent Application 20130297470 provides a method of opening and managing multiple term deposit products. This method comprises the step of providing a management software interface to a financial institution via an electronic network wherein the management software interface is connected to a computer and has a user software interface. The method further accesses the user software interface via the electronic network by a customer of the financial institution; and opens a single term deposit account through the user software interface. Then multiple term deposit products are opened within the single term deposit account through the user software interface. The management software interface manages the multiple term deposit products within the single term deposit account based upon the financial institution's instructions.

This invention merely provides a method of opening and managing multiple term deposit products where each product is tied to an individual savings objective and exists within a single term deposit account.

This prior art does not provide any function for the client or the financial institution to perform any KYC process. It does not provide the function of allowing the customer to view and compare different financial products.

Any discussion of the prior art throughout the specification should in no way be considered as an admission that such prior art is widely known or forms part of common general knowledge in the field.

### SUMMARY

### Problems To Be Solved

It an objective of the present invention to provide an electronic security system and method for investment transaction which provides a centralised KYC service for multiple bank account.

It is an objective of the present invention to overcome or ameliorate at least one of the disadvantages of the prior art, or to provide a useful alternative.

It is one aspect of the present invention to provide an electronic security method for investment transaction comprising the step of:
receiving personal information data of a customer from a client system;
receiving one or more document files containing information of the customer from the client system, wherein the one or more document files comprise one or more images, identification documents, and bank statements;
connecting to a secured database to verify the information of the personal information data;
providing one or more financial products for the customer to select for investment;
receiving an investment order for one or more financial products;
preparing and forwarding an investment order ticket to a financial institution; and
forwarding a settlement command to a settlement facility.

Preferably, the electronic security method for investment transaction further comprises the step of receiving a digital credential as a result of verifying the information one the personal information data with the secured database.

Preferably, the information one the personal information data is verified in compliance with Know Your Customer rules.

Preferably, the step of connecting to a secured database to verify the information one the personal information data is carried out automatically between a predetermined time interval, wherein the value of the predetermined time interval is received from the client system.

Preferably, the investment order ticket comprises the investment order, personal information, and the digital credential.

Preferably, the investment order ticket comprises the investment order, personal information, and the one or more document files.

Preferably, personal information data comprises one or more of name, date of birth, and address.

Preferably, the one or more of identification documents comprises passport, drivers licence, Medicare card, and social security card.

Preferably, the electronic security method for investment transaction further comprises the step of fetching financial products information with one or more application programming interface (API).

Preferably, the electronic security method for investment transaction further comprises the step of displaying a comparison table of the financial products.

Preferably, the information of the financial products displayed has been filtered in accordance with the digital credential of the customer.

It is another aspect of the present invention to provide a computer system comprising:
a processor,
at least one memory module, and
one or more input/output (I/O) interface; wherein the I/O interface comprise a network interface for communicating via a computer network;
wherein the one or more I/O interfaces are adapted to:
receives personal information data of a customer from a client system and store in the memory module;
receives one or more document files containing information of the customer from the client system and store in the memory module, wherein the one or more document files comprise one or more images, identification documents, and bank statements;
wherein the processor instructs the I/O interface to connect to a secured database and retrieve third parties data for comparing the information of the personal information data;
wherein the I/O interface is adapted to send one or more financial products to a display on a computer system for the customer to select for investment;
such that when the processor receives an investment order for one or more financial products, the processor prepares and forwards an investment order ticket to a financial institution; and then forwards a settlement command to a settlement facility.

Preferably, the I/O interfaces is adapted to receiving a digital credential as a result of verifying the information one the personal information data with the secured database.

Preferably, the I/O interface is adapted to connecting to a secured database to verify the information one the personal information data is carried out periodically.

Preferably, the processor instructs the I/O interface to send signals to display a comparison table of the financial products on the display.

### BRIEF DESCRIPTION OF THE FIGURES

FIG. 1 is a transaction flow diagram of a computer system according to a preferred embodiment of the present invention;

FIG. 2 is flow chart of a user process of the computer system of FIG. 1;

FIG. 3 is flow chart of a KYC process of the computer system of FIG. 1;

FIG. 4 is a system components design of a computer system according to a preferred embodiment of the present invention; and

FIG. 5 illustrates a system states flow diagram of a computer system according to FIG. 1.

### DESCRIPTION OF THE INVENTION

Preferred embodiments of the invention will now be described with reference to the accompanying drawings and non-limiting examples.

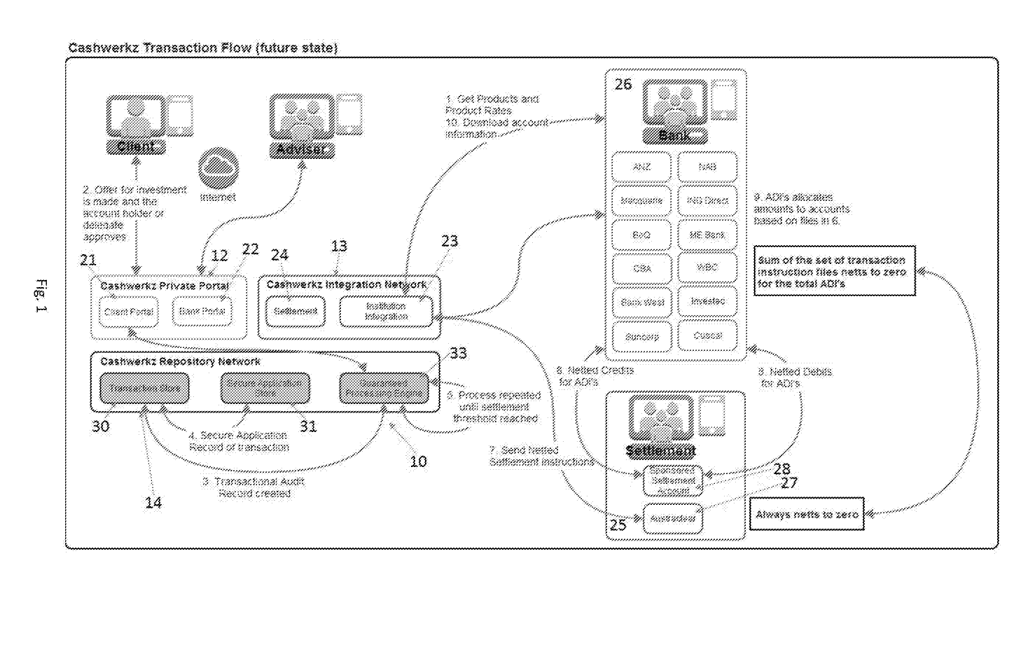

Referring to FIG. 1, a transaction flow of an embodiment of the present invention is shown. The system 10 of the present invention comprises a server having one or more I/O interfaces, central processing unit and one or more memory modules (volatile and non-volatile). The term interface(s) referred hereafter comprises hardware/software interface(s), and application programming/user interface(s) (graphic and non-graphic). The I/O interfaces include a network interface connecting to a network (Internet, intranet or extranet, etc). The conceptual architecture of the system 10 can generally divided into a private portal module 12 (also referred as “CashWerkz Private Portal”), a integration network module 13 (also referred as “CashWerkz Integration Network”), and a repository network module 14 (also referred as “CashWerkz Repository Network”).

The private portal module 12 is adapted to provide and manage the interfaces for the customers including individual clients and institutions. To suit different needs and requirements of different customers, the private portal module 12 comprises a client portal module 21 for providing and managing interfaces for individual customer. A customer can access the services of system 10 through the client portal. The private portal module 12 also comprises a bank portal 22 for institutional clients to access the system 10.

The integration network module 13 comprises an institution integration module 23 and a settlement module 24. The institution integration 23 is adapted to get products information including product rates from different entities such as retailer banks, commercial and investment banks, insurance companies, and other financial institutions, etc. The settlement modules 24 is adapted to interact with a settlement system 25 for settling a transaction process. This includes the process of sending netted settlement instructions to a financial institution 26 such as ANZ bank, BoQ, Bank West, CBA, etc and to a computerised clearing and settlement facility 27 such as Austraclear. All of these transactions have to be carried out electronically. The settlement system 25 further comprises a sponsored settlement account 28 to interface with the bank system 29 for credit and debit process with the Authorised Deposit-taking Institutions (ADIs).

The repository network module 14 comprises a transaction store 30, a secure application store 31 and a guaranteed processing engine 33. When a customer initiates a transaction by making an offer for investment, the client portal module 21 sends all the transaction information to the guaranteed transaction engine 33. The guaranteed transaction engine 33 creates a transaction audit record, stores the information of the transaction in the transaction store 30 and secures the application records of the transaction in the secure application store. The guaranteed processing engine 33 keeps process transactions until the settlement threshold is reached. The guaranteed processing engine 33 then calls the settlement interfaces provided by the settlement module 24 of the integration network module 13 to proceed to perform settlement as described above.

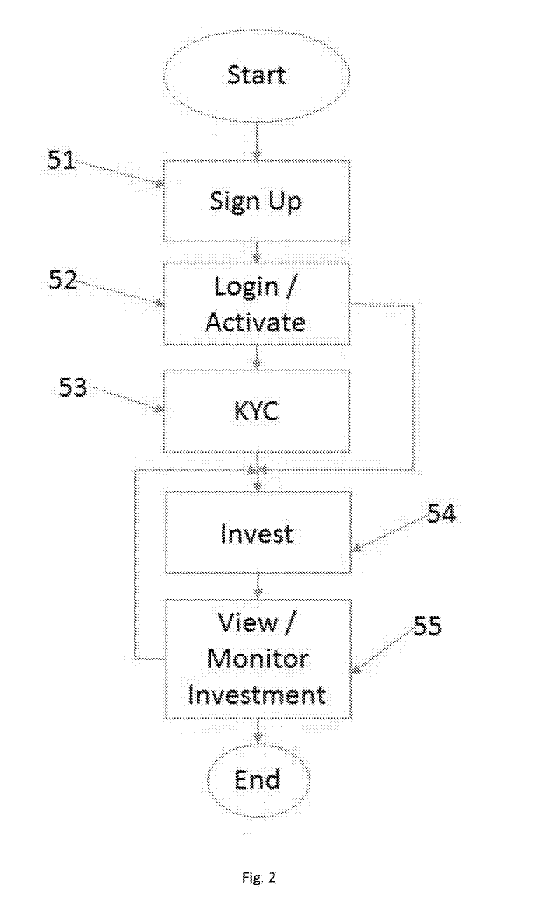

Referring to FIG. 2, there is shown a flow diagram of one process performed by a system 10 of an embodiment of the present invention. A customer may sign up an account 51 or login 52 into an account through the client portal module 21 of the private portal module 12. After the customer signs up an account 52, the system 10 requires the customer to upload one or more documents to pass the “Know Your Client” (KYC) compliance process 53. When the customer logins 52 into an account, the system 10 does not force the client to go through the KYC compliance process 53, but the customer may opt to submit additional documents for the KYC compliance process. After the KYC compliance process 53, the system 10, the system then allows the client to initiate the investment function 54. In the investment function 54, the customer can request the system 10 to retrieve information of different financial products from a database. The pricing analysis module 135 and pricing engine 126 can retrieve products information from the database and display the products based on the KYC compliance level a customer. The system 10 then allows the customer to select the product to invent on. The customer may monitor and view the investment progress 55 through the system 10. After the investment matured, the system 10 can retrieve one or more financial products from the database, compare the KYC compliance level recorded in the system 10, and accept another investment for a financial product selection from the client.

The KYC process 53 can be replaced by other identification service. In one embodiment, the KYC process 53 is replaced by distributed block chain identification. In this embodiment, the customer uploads a document for verification—it is referred in this paragraph as a transaction. Once the verification is done and the document is verified to be valid, the system 10 only stores the transaction in the blockchain database.

In another embodiment, the block chain mechanism is used to guarantee the integrity of a document. A customer uploads a document to his or her profile for verification. The document is certified via embedding its hash value in the blockchain. This is done by generating a special transaction that encodes/contains the hash via a script. This is a scripting that marks the transaction output as provably unspendable and allows a small amount of data to be inserted, which in this case is the document's hash, plus a marker to identify all of this transactions. Once the transaction is confirmed, the document is permanently certified and proven to exist at least as early as the time the transaction was confirmed.

Next time when the customer upload the same file, the system 10 can verify the document by performing a hash comparison and carry out the follow these steps: Calculate the document's hash value by finding a transaction in the blockchain containing an OP_RETURN output with the document's hash prepended by the marker bytes, which are 0x444f4350524f4f46 (or ‘DOCPROOF’ in ascii). The existence of that transaction in the blockchain proves that the document existed at the time the transaction got included into a block.

In another application of the present embodiment, the customer identification is verified and a block chain identification is created. The identification process may include sub-routine for verifying identification documents and keeping a hash records to prove the existence of the documents.

Typically, a financial institution has to request the customer to go through the KYC compliance process again and determine whether the customer satisfies the required KYC compliance level or not. The system 10 of the present invention has already hold all the documents (passports, bank statement, other identifications) and has already verified that the customer has passed the KYC compliance process, the system may send the application for the newly selected financial product with a digital security certificate of the KYC compliance process to the financial institution. The customer has no need to go through the KYC compliance process and has no need to fill out the investment form again.

When the customer selects a new investment product from the system 10 through the client portal 21 of the private portal 12, the guaranteed processing engine 33 can retrieve the customer information from the database of the system to prepare the application. The customer information required may different according to the different requirements of the financial institutions. This was handled by the institution integration module 23 which retrieved the financial products information from different financial institutions 26. The integration modules 23 can analyse the information required for applying a financial products. System 10 then retrieves all the required information and the digital security certification or credential as a result of the KYC compliance process and submit the application for the financial product to the financial institution 26. In one preferred embodiment, the application is encoded in an investment order ticket.

In one preferred embodiment, the submission is carried out by calling an application programming interface (API) provided by the financial institution. After receiving the API request, the financial institution information system can process the application immediate and return a successful value to the system 10.

In one of the preferred embodiments, the system 10 comprises a periodic process module 135 which can periodically submit the client documents for KYC compliance process. Each verification will produce a new digital security certificate or credential. The system 10 can distribute this digital security certificate to all the financial institutions that the client has investments in. This is done by retrieving the institutions name of all the current investments of the client from the client profile. In this way, the financial institutions may also discharge their ongoing KYC obligations. When the client moves from one product to another, the digital security certificate will be current and taken into account of the recent business activities.

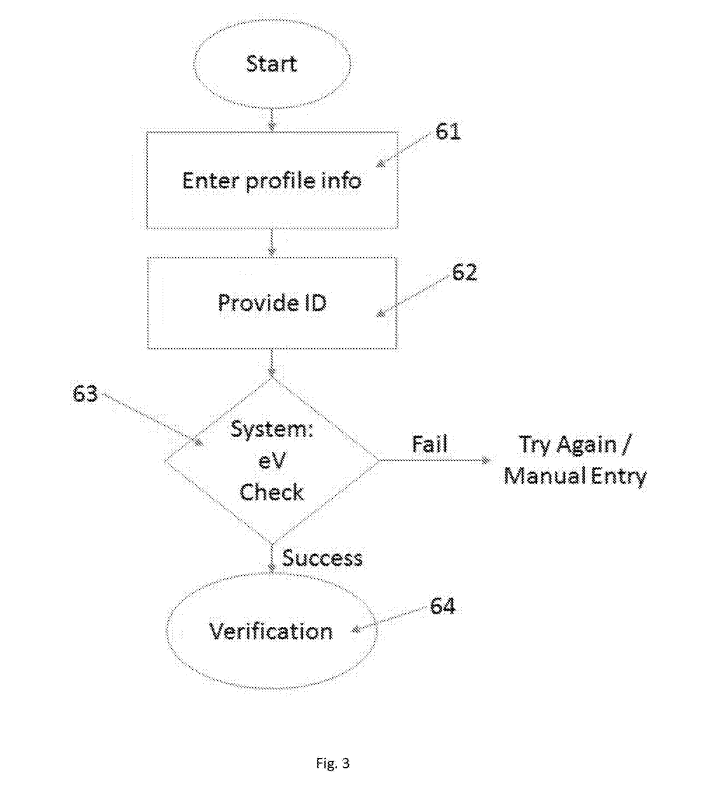

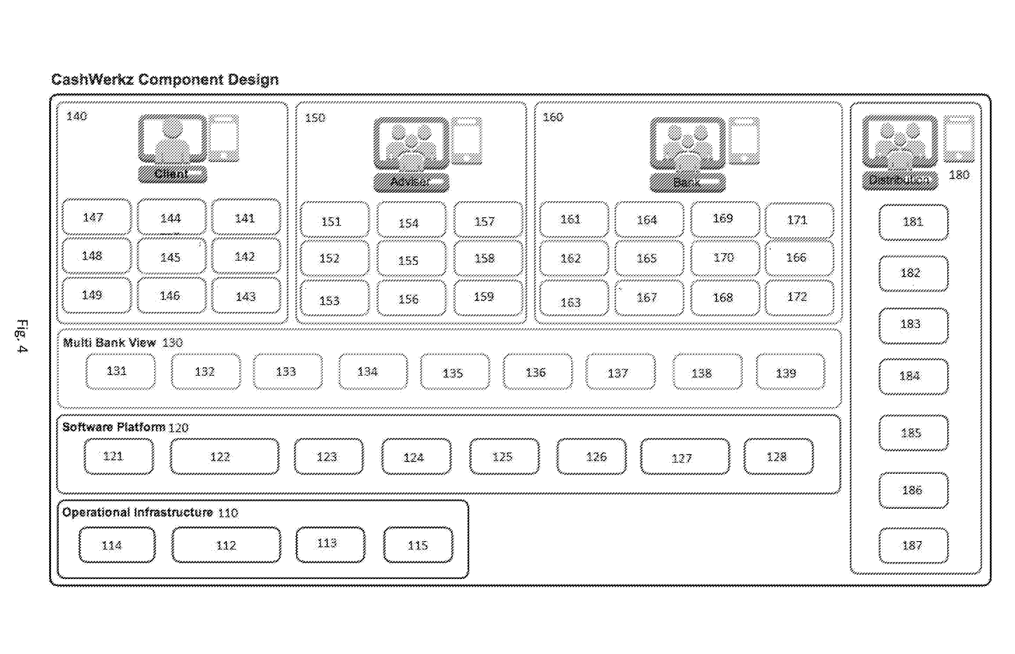

The advantage of the system 10 of an embodiment of the present invention is to provide a system for a customer to create an investment profile. In this process, the system will perform the KYC verification process as shown in FIG. 3. The system 10 will request the profile information from the user as shown in step 31. The profile information may include the user name and password of a user. Further, the customer may require input of personal details such as name, date of birth, place of birth and address. The KYC process is to ensure that the customer is the person the customer claimed to be.

Next, the system 10 will require the customer to provide different forms of identification documents as shown in step 32. The system 10 will request the customer to upload different sort of documents, such as passport, driver licence, birth certificate, bank statements, etc. The system 10 will stores these documents in a distributed hypermedia database 127. The system 10 may process these documents by reading the information from these documents. In one preferred embodiment, the system 10 will scan the documents and then perform optical character recognition. In another embodiment, the system 10 will scan the bar code on the documents.

The system 10 will then verify the information of the customer as shown in step 33. The system 10 will inspect the information extract from the documents in step 32. The system 10 may determine the type of documents received and issue a query to the database for each type of information. The system 10 may further verify the data retrieved and the data entered by the customer. In another embodiment, the verification step 33 further involves the checking on the personal details from a third part database. In one example, the system 10 will send a query to the credit rating database and determine the financial status of the customer.

If the information from the customer is verified, the system 10 will issue a KYC digital certificate or credential as shown in step 34. The user profile of the customer will store this digital certificate or credential as a record. In one embodiment, when a customer decided to open a new account in a financial institution, the system 10 can provide the necessary inform along with the KYC certificate. The financial institution may use this KYC digital certificate or credential to support that it has discharged its KYC obligation. In another embodiment, the system 10 will direct all data including the uploaded documents to the financial to open an account.

In the situation that the information from the customer cannot be verified, the system 10 will send an error message to the customer's system. The system 10 will hold the documents uploaded. The customer may choose to upload further document, and provide more information. In another embodiment, the customer may choose to have his or her identification verified manually.

Reference is made to FIG. 4 the component design diagram of the present invention. The present invention comprises an operational infrastructure 110 comprising a local physical system 112 connected to a private cloud 113. Additional to these two components, the operation infrastructure 110 may also have a development platform 114 and a service desk 115. The physical system 112 typically comprises at least a computer server having one or more I/O interfaces, central processing unit and memory modules (volatile and non-volatile). The I/O interfaces include a network interface for connecting the physical system 12 to the private cloud. This connection may go through a private proprietary network. Alternatively, the connection may go through a public network such as the Internet through a virtual private network.

The development platform 114 is for system development of the future release of the present invention. Typically the development platform comprises the same hardware of the physical system 112 unless the new release includes an upgrade of hardware. The development platform 114 may be able to connect to the private cloud 113 but usually the development platform 114 could not access to the services and data of the production system. The development platform 14 may have access to a separate services provider and a mirrored data set of the production system. Testing of the new release of software and hardware is performed in the development platform 114. Once the new release of software or hardware passes the testing stage, it can be deployed to the production system. The development platform 114 can then be used for the next new release of software or hardware.

The service desk 115 is usually installed in another physical system to provide support and other services to all the stakeholders including users of the client system 140 which are referred to as customers, users of the advisor system 150, users of the bank system 160 and users of the distribution system 170. It may also provide support to the administrators of the multibank view system 130, software platform 120 and operational infrastructure 110. The service desk 115 can be installed in an offshore service centre and the staff of the service desk 115 may have access other part of the system through the private cloud 113.

The modularity of the operational platform 110 provides security and integrity to the production system. The status of the development platform 114 and the service desk 115 will not affect the performance of the production system which includes the local platform 112 and the private cloud 113. The staff of the development system 114 and the service desk 115 may be given different type of credential for providing different kind of supports. Some staff may have credential only to access the hardware and the development system 114. Other staff may have credential to access personal data of the live system.

The software platform 120 is installed on the operation infrastructure 110. The software platform 120 comprises one or more of secure stores 121, a distributed finite state machine 122, a transaction processing system (TPS) 123, an account management system 124, a billing system 125, pricing engine 126, a distributed hypermedia database 127 and an access management, entitlements and federation server platform 128.

The secure store 121 provides a secure repository for storing and retrieve user credentials. These credentials usually consist of a user identity and password, but can also contain other fields. The distributed finite state machine (FSM) 122 defines and controls the system flow and different states of the present invention. The current invention comprises a number of systems including the client system 140, advisor system 150, bank system 160, distribution system 180, and multibank view system 130 which are installed in distributed system architecture. The distributed FSM 122 can control the system flow and system states of all these separate systems. The transaction processing system (TPS) 123 is responsible for handling transaction which are required to satisfy the ACID criteria. The TPS 123 can ensure the atomicity, consistency, isolation and durability of the transaction process. The account management system 124 stores the user profiles and handles their account management. The account management system 124 is responsible to manage user account data and account profile. A user can view and edit the account data through the account management system 124. However, there are certain types of data in the system which cannot be displayed to the owner of the account by law, and there are also certain types of data which cannot be altered by any of the users. The account management system 24 therefore also controls which data from a user profile is accessible by a user.

The billing engine 125 is responsible for billing the customers. It records the bills issued to the customer and the payment. The billing system 125 can also produce periodic reports regarding to billing in compliancy with taxation legislation. In one embodiment, the billing system 125 can produce report which can import to a third party accounting or taxing software. In another embodiment, the billing system 125 can integrate with an accounting system.

The pricing engine 126 is responsible for managing and comparing different security products such as fixed income security products. The pricing engine 126 may receive raw data from different data sources in different format. Some of the data may come from a direct feed of a financial institution; some from a third party distributor, some from manual input. Different products may have different purchasing criteria such as different level of security clearance, minimum deposit, mature time, etc. The pricing engine 126 is responsible for taking in all different kind of data in different format and organising them in a common platform, comparing and ranking different products. The comparison and ranking process is carried out based on the personal profile of a customer. Each customer may have a different predetermined performance target (in term of value and mature time). Each customer may also have a different security clearance. Therefore, even with the same set of products data, the pricing engine 126 can provide a different comparison and ranking results to different users.

The software platform 120 further comprising distributed hypermedia database 127 which is adapted to store a variety of interactive and non-interactive multimedia such as document of various format (doe, txt, pdf, rtf, TeX, txt) and images (bmp, jpg, gif, png, tiff).

The access management, entitlements and federation server platform 128 is implemented as Open AM which provides authentication and authorisation services. It also provides a single sign on (SSO) mechanism for a user to access different part of the system and request different services from the system.

The multi bank view system 130 is responsible for organising and presenting the information and interface for the users. The multi bank view system 130 comprises a bank supervisor module 131, a local client module 132 (also referred as “cashwerkz client” module), a common client module 133, a meta product module 134, a periodic processes module 135, a pricing analysis module 136, product transactions module 137, a monitoring module 138, and a product aggregation module 39.

The bank supervisor module 131 is adapted to provide and manage the interfaces for the bank system 160. The local client module 132 (also referred as CashWerkz client module) is adapted to provide and manage the interfaces for the client system 140. The common client module 133 is adapted to provide and manage the interfaces for the bank system 160 and distribution system 180. The meta product module 134 is adapted to provide and manage the interfaces for handling different types and formats of information and meta data for investment products. The meta product module 134 provides and manages interfaces for products and prices comparison services, and market comparison services. The periodic processes module 135 is responsible providing and managing interfaces to handle recurring actions such as updates and charges. The pricing analysis module 136 provides and manages interfaces to perform analysis, comparison, projection and modelling for product pricings. The product transaction module 137 provides and manages interfaces for product transaction. There is also a monitoring module 138 which is adapted to provide and manage the interfaces for monitor different processes including investment process and progress, and other functions of the system. The product aggregation module 139 is adapted to provide and manage interfaces for products information retrieve and aggregation.

The client system 140 provides an individual customer access for the system of the present invention. The client system 140 may be a PC workstation, a laptop computer, a tablet, mobile or other smart devices. Through the client system 140, the customer can access user history 141, analytic information 142, user transactions 143, user portfolio 144, performance reports 145, legal entity for KYC (know your customer) 46, product preferences 147, market comparison 148 and maturities 149.

The advisor system 150 allows a financial advisor or fund manager which manages investment for a plurality of clients to access the system of the present invention. The advisor system 150 may be a PC workstation, a laptop computer, a tablet, mobile or other smart devices. The advisor system 150 provides the client onboarding service 151 and bulk transactions services 152. The advisor system 150 can displays a transaction status list 153. The advisor system 150 has interface to allow financial advisors to manage investment mandates 154 and Know Your Client (KYC)/Anti Money Laundering (AML) compliance 155. The advisor system can produce fee reports 156, client maturities reports 157 and market comparison report 158. The advisor system 150 also provides interface for CRM integration 149.

The bank system 160 allows staff from the banks and financial institutions to access the system of the present invention. The bank system 160 may be a PC workstation, a laptop computer, a tablet, mobile or other smart devices. The bank system 160 has a marketing portal 161 for a bank to upload and promote it products. The product information can be uploaded through a product information interface 162. The KYC/AML documents system 163 allows the banks to manage documents with different file formats for the purpose of KYC/AML compliance. There is a bank content interface 164 for updating general information of the bank, and a product pricing interface 65 for managing and displaying the products pricing. The bank system 160 also provides a transaction list 166 and transaction status list interface 167 to display the transaction status lists and produce reports in relation to the transaction status. Similarly the customer list interface 168 allows the user to manage, display and produce reports in relation to customer lists. Preferably, the bank system 160 comprises bank integration interface 169 for requesting and providing system services for the information system from a bank or a financial institution. The bank system 160 also has a fund transfer interface 170 for transferring fund from one entity to another entity. There is also provided a bank report service 171 for each bank to generate different kind of reports from data retrieved from the system 10. Also the client maturities reporting services 172 can retrieve one or more clients and their investment products information. The client maturities reporting services 172 then calculates the maturity period of each investment products and produce different kind of maturities report.

The distribution system 180 provides interfaces for other kind of investment administrators for distribution products. The distribution system 180 may be a PC workstation, a laptop computer, a tablet, mobile or other smart devices. The SMSF administration interface 181 allows an administrator of a Self-Managed Superannuation Fund (SMSF) to managed and organised SMSF products. The Industrial Super interface 182 allows an administrator of an Industrial Superannuation Fund to managed and organised Industrial Superannuation Fund products. The distribution system 180 also provides interfaces for administrators of wrap accounts 183, master trusts 184, high net worth products 185, corporate markets 186 and not for profit sectors 187.

In one embodiment, the software platform of the system 10 include AngularJS, Spring Framework, Java and MonogoDB.

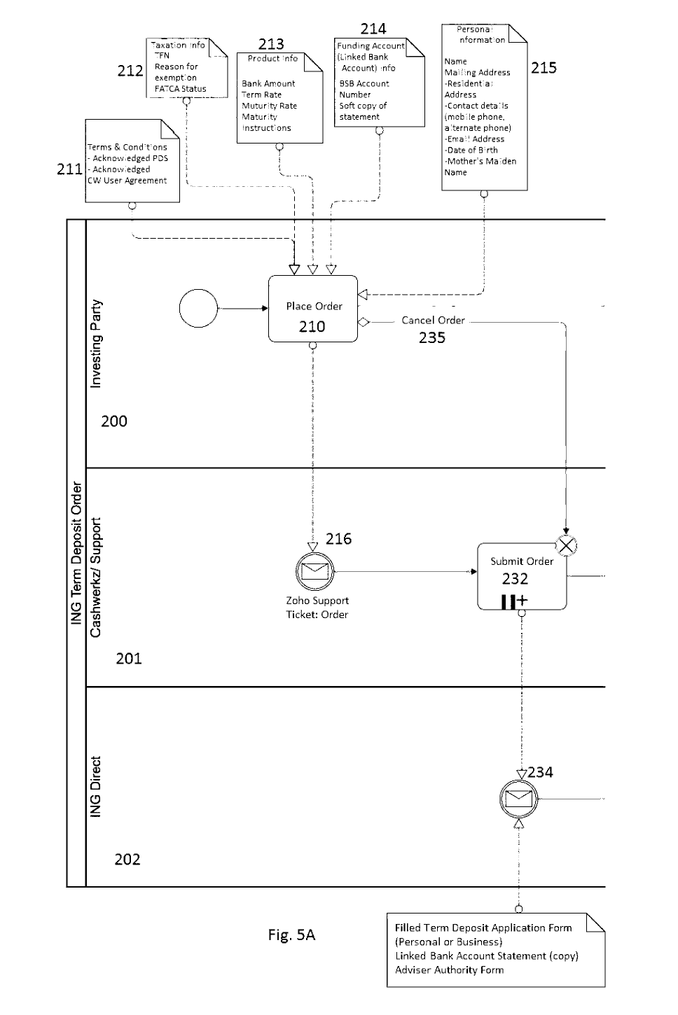

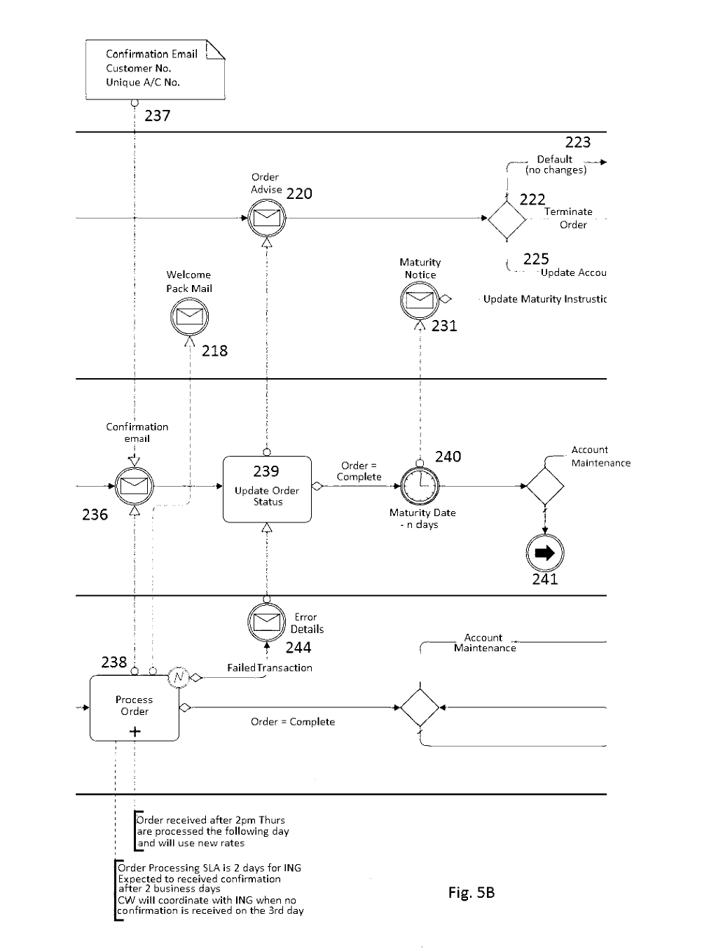

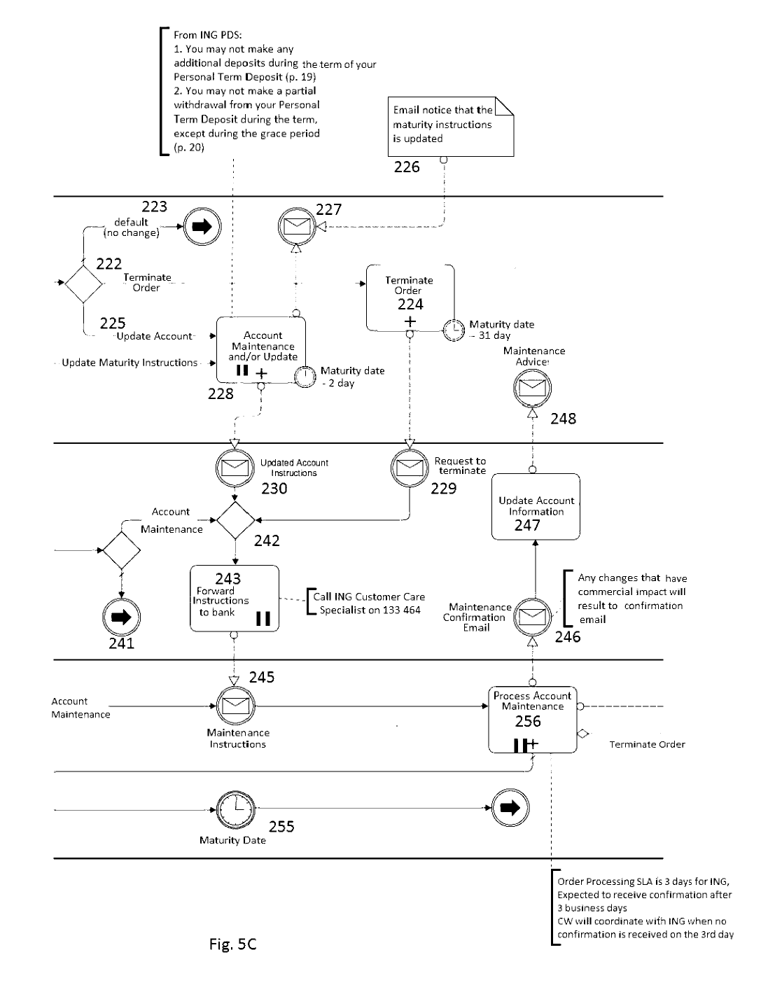

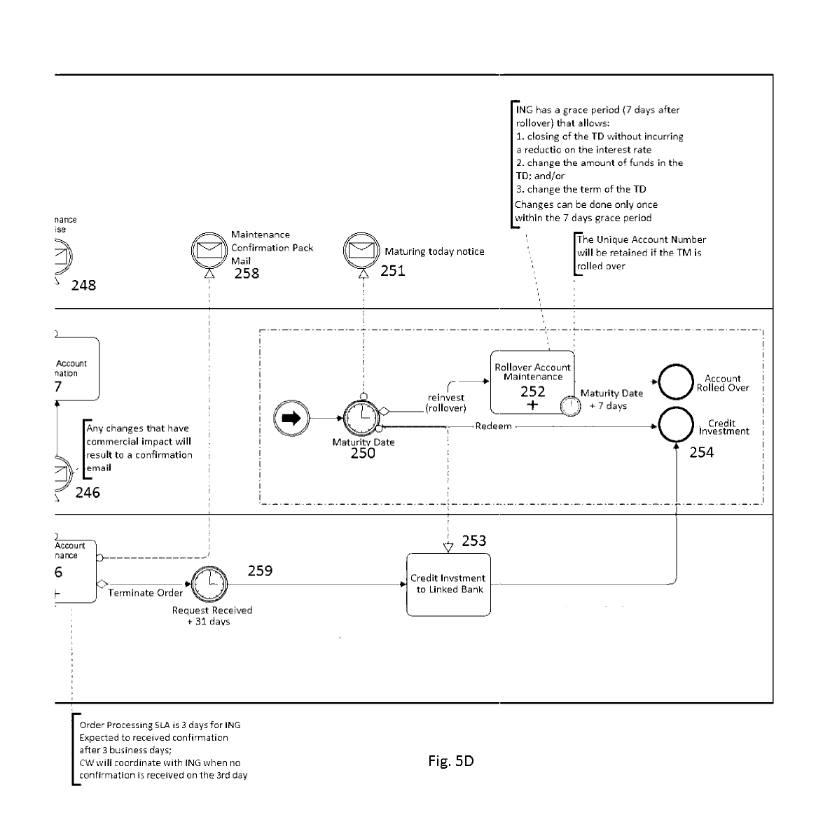

Reference is now made to FIG. 5, which shows a system states diagram for a customer to place a term deposit order according to an embodiment of the present invention. After a customer login to the customer profile as shown in FIG. 2 step 51 or 52, and has the KYC digital certificate ready, the customer may place an order for term deposit in a bank.

The customer interacts with the client system 200 to place an order 210, the client system 200 will fetch a plurality of records from different database. These records include: the terms and conditions of that product 211, taxation information 212, product information 213, funding account information 214, and personal information 215. The terms and conditions information usually includes a product disclosure statement and the user agreement. These records are periodically fetched digitally from different financial institutions with the periodic process module 135. The taxation information typically consists of the tax file number (TFN), any reason for exemption of tax and (Foreign Account Tax Compliance Act) FATCA Status. The production information 214 may comprise: name of the issuer, amount, term, rate, maturity data and maturity instruction. The funding account information is the information from which the customer draws money to buy a product. The funding account information includes the information of the financial institution, BSB, account name, account number and soft copy of the statement. The personal information 205 is typically retrieved from the personal profile stored in the database. The personal information 215 includes: name, mailing address, residential address, contact detail (mobile phone, alternative phone), email address, date of birth, mother's maiden name

The client system 200 then sends an investment order ticket 216 to the server system 201. The client system 200 waits for the order advice 220 to indicate the result of the order submission. If the order is successful, the client system 200 will wait for the next action. A customer may then leave the order to mature 223 without initiating any further action. The customer may request to terminate the order. The client system 200 will change to order termination state 224. When the client system 200 receives a termination request 222, the client system will forward the termination request 229 to the server system 200.

The customer may choose to update the order 225. This is handled by the account maintenance and/or maturity instructions update 228. When the account maintenance and/or maturity instructions update 228 receives an update receipt, it will notify 227 the customer. In one embodiment, the notification is carried out through email notice 226. The account maintenance and/or maturity instructions update 228 also takes receipt from the server system 201 regarding the maturity of the investment product. When it receives the maturity notice 231, it will notify the customer by sending email notice 226.

The server system 201 is adapted to receive an investment order ticket 216 from the client system 200. When the server system 201 received an investment order ticket 216, it will put in the submit order states 232. A customer may seek to cancel the order immediate by sending a cancel order command 235 to the server system 200.

When the order is confirmed for submission, the server system will forward all the order submission 234 to the system of financial institution 202. The server system 201 then waits for the confirmation notice 236 of the order form the system of the financial institution 202. This confirmation notice 237 will be forwarded to the customer. In one embodiment, the confirmation email 237 includes the customer number, and unique account number.

The system server 201 then waits for the confirmation notice of the order from the financial institution. In the event that the order is failed, the server system 201 is expected to receive a notice of the error details 244 from the financial institution. The server system then sends an order advice 220 to the client system 200. The order status stored in the server system and customer profile is set to a complete status. The server system 201 then periodically checks and waits for the investment to mature 240. When the produce is mature, the server system 201 will send a maturity notice 231 to the client system 200.

In the event that a product is mature, a customer may leave the product in status quo ante 241. The server system 201 may also has stored instructions to update the product when mature.

The server system 201 is adapted to receive update account instruction 230 from the client system 200, the termination request 229 from the client system, or ongoing account maintenance instructions in the server system. The server system will forward these instructions 243 to the financial institution as the maintenance instruction notice 245.

When the server system 201 receives a maintenance notice 246, the server system will update the account information 247 accordingly. The maintenance notice 246 includes any changes that have commercial impact. In a preferred embodiment, the maintenance 246 is encoded in a confirmation electronic mail message with UTF-8.

The server system 201 is programmed to automatically monitor the maturity of all the products in a predetermined time interval. Any predetermined time interval can be downloaded from a server or change When the maturity date 250 of a product arrives, the server system 201 will send out a maturity today notice 251 to the customer. The customer may reinvest by rolling the account over 252. In a preferred embodiment, the unique account number will be retained if the product is rolled over.

When the product matures, there will be interest paid to the customer. The customer may redeem the interest which in turn will credit to the client's nominated account 253. Alternative, the client may choose to re-invest with the interest 254.

In a prefer embodiment, the system of financial institution 202 is adapted to receive an investment order submission 234 and process the order 238. In the event that the order fails, the system 202 will send out a notice with the error details 244. In the event that the order is successful, a successful notice 218 will be sent. In one embodiment, the successful notice 218 is a welcome pack.

Then the system 202 will wait for further actions. In one case, there is no further update and the product is left to mature.

In the event that the system 202 receives a maintenance notice 245, the system will process account maintenance 256. In one embodiment, a maintenance confirmation pack will be sent 258.

When the product is mature and without any further instruction, the product will be terminated. Alternative the system 202 may also receive a termination order. In this event, the termination will be confirmed after a predefined period such as 31 day of the receipt of the termination request 259. The system 202 then calculates the settlement value and transfers the money into the customer's nominated account 253.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1-22. (canceled)

23. A computer system comprising:
a processor,
at least one memory module, and
one or more input/output (I/O) interface; wherein the I/O interface comprise a network interface for communicating via a computer network;
wherein the one or more I/O interfaces are adapted to:
receiving personal information data of a customer from a client system and store in the memory module;
receiving one or more document files containing information of the customer from the client system and store in the memory module, wherein the one or more document files comprise one or more images, identification documents, and bank statements;
wherein the processor instructs the I/O interface to connect to a secured database and retrieve third parties data for comparing the information of the personal information data;
wherein the I/O interface is adapted to send one or more financial products to a display on a computer system for the customer to select for investment;
such that when the processor receives an investment order for one or more financial products, the processor prepares and forwards an investment order ticket to a financial institution; and then forwards a settlement command to a settlement facility.

24. An electronic security method for investment transaction according to claim 23, wherein the I/O interfaces is adapted to receiving a digital credential as a result of verifying the information one the personal information data with the secured database.

25. An electronic security method for investment transaction according to claim 23, wherein the information one the personal information data is verified in compliance with Know Your Customer rules.

26. An electronic security method for investment transaction according to claim 23, wherein the I/O interface is adapted to connecting to a secured database to verify the information one the personal information data is carried out periodically.

27. An electronic security method for investment transaction according to claim 23, wherein the investment order ticket comprises the investment order, personal information, and the digital credential.

28. An electronic security method for investment transaction according to claim 23, wherein the investment order ticket comprises the investment order, personal information, and the one or more document files.

29. An electronic security method for investment transaction according to claim 23, wherein personal information data comprises one or more of name, date of birth, and address.

30. An electronic security method for investment transaction according to claim 23, wherein the one or more of identification documents comprises passport, driver licence, Medicare card, and social security card.

31. An electronic security method for investment transaction according to claim 23, wherein the processor is adapted to fetch financial products information with one or more application programming interface.

32. An electronic security method for investment transaction according to claim 23, wherein the processor instructs the I/O interface to send signals to display a comparison table of the financial products on the display, and wherein the information of the financial products displayed has been filtered in accordance with the digital credential of the customer.

33. An electronic security method for investment transaction comprising the steps of:
receiving personal information data of a customer from a client system;
receiving one or more document files containing information of the customer from the client system, wherein the one or more document files comprise one or more images, identification documents, and bank statements;
connecting to a secured database to verify the information of the personal information data;
providing one or more financial products for the customer to select for investment;
receiving an investment order for one or more financial products;
preparing and forwarding an investment order ticket to a financial institution; and
forwarding a settlement command to a settlement facility.

34. An electronic security method for investment transaction according to claim 33 further comprising the step of receiving a digital credential as a result of verifying the information one the personal information data with the secured database.

35. An electronic security method for investment transaction according to claim 33, wherein the information one the personal information data is verified in compliance with Know Your Customer rules.

36. An electronic security method for investment transaction according to claim 33, wherein the step of connecting to a secured database to verify the information one the personal information data is carried out automatically between a predetermined time interval, wherein the value of the predetermined time interval is received from the client system.

37. An electronic security method for investment transaction according to claim 33, wherein the investment order ticket comprises the investment order, personal information, and the digital credential.

38. An electronic security method for investment transaction according to claim 33, wherein the investment order ticket comprises the investment order, personal information, and the one or more document files.

39. An electronic security method for investment transaction according to claim 33, wherein personal information data comprises one or more of name, date of birth, and address.

40. An electronic security method for investment transaction according to claim 33, wherein the one or more of identification documents comprises passport, driver licence, Medicare card, and social security card.

41. An electronic security method for investment transaction according to claim 33, further comprising the step of fetching financial products information with one or more application programming interface.

42. An electronic security method for investment transaction according to claim 33, further comprising the step of displaying a comparison table of the financial products, and wherein the information of the financial products displayed has been filtered in accordance with the digital credential of the customer.
